(19) United States
(12) Patent Application Publication
(10) Pub. No.: US 2010/0175268 A1
(43) Pub. Date: Jul. 15, 2010

(54) DEVICE FOR CUTTING OUT MATERIAL SUCH AS PAPER OR CARDBOARD

(76) Inventor: Arnaud Senesi, Eaubonne (FR)

Correspondence Address: YOUNG & THOMPSON, 209 Madison Street, Suite 500, Alexandria, VA, 22314, US

(21) Appl. No.: 12/602,115

(22) PCT Filed: May 15, 2008
(86) PCT No.: PCT/FR08/00694

§ 371 Date: Jan. 22, 2010

(30) Foreign Application Priority Data
May 31, 2007 (FR) 0703896

(51) Int. Cl. B26B 5/00; B26B 27/00; B26B 29/02; B26B 29/06

(52) U.S. Cl. 30/162; 30/164; 30/296.1; 30/278; 30/289; 83/520

(57) ABSTRACT

The device (1) according to the invention makes it possible to cut out material such as paper or cardboard. It comprises a body (2) which includes handling means, and means of fixing at least one blade (6), possibly retractable, one end of which extends projecting relative to a determined area of the surface of the body (2), in the position of use of the device (1). It is characterized in that the height of the blade (6) extending beyond the abovementioned area is between 10 microns and 10⁴ microns, preferably 10² microns, and in that said area presents a relatively large surface area, of the order of 0.5 to 15 cm².

### BACKGROUND OF THE INVENTION

1. Field of the Invention

The object of the present invention is a device for proceeding with cuttings. It notably but not exclusively, relates to a device which may be used by children quite safely and which allows paper or cardboard to be cut out.

2. Description of the Prior Art

It is known that there exist devices with which paper or cardboard may be cut, which consist of a sliding blade in a handle with a slide. Nevertheless, these cutter type devices are dangerous, notably for children, because of the extremely sharpness of their blade. Further, the handle of these cutters does not have ergonomics adapted to the hands of children, which makes their use difficult by the latter.

### OBJECT OF THE INVENTION

More particularly the object of the invention is to suppress these drawbacks by proposing a device with which it is possible to proceed with cutting out material such as paper or cardboard, comprising a body having ergonomics adapted to children, as well as at least one blade positioned so as to not form a risk of injury for the users.

### SUMMARY OF THE INVENTION

For this purpose, it proposes a device with which it is possible to proceed with cutting out material such paper or cardboard, comprising a body which comprises gripping means and means for attaching at least one optionally retractable blade, one end of which extends protruding relatively to a determined area of the surface of the body, in the position of use of the device, characterized in that the height of the blade jutting out from the aforesaid area is comprised between 10 microns and 10⁴ microns, preferably 10² microns and in that said area has a relatively large surface area of the order of 0.5 to 15 cm².

In this device, the height of the protruding portion of the blade is just sufficient for carrying out for example the cutting-out of a sheet of standard thickness, i.e. 0.1 millimeter.

Nevertheless, contrary to the prejudices of one skilled in the art, this blade is not capable of making cuts on the skin of a user, for example of a child. Indeed, taking into account the extent of the supporting surface surrounding the blade, the pressure exerted on the skin will not be significant and cannot generate a punching effect. Consequently, at the blade, the skin retains its flexibility and withdraws upon contacting the blade (all the more since the height of the blade is small). The sharp edge of the blade will therefore slide on the external relatively hard layer of the epidermis, by pushing it back gradually. The obtained effect (absence of cuts) is relatively surprising.

Advantageously, the upper portion of the body of the device according to the invention may have shape conformity with that of the palm of the hand of a child so that the latter may hold said device according to the invention with ease and steadiness. Preferentially, the upper portion of the body of the device according to the invention is convex while its lower portion comprises at least three supporting points with which great stability may be provided to said body.

Advantageously the body of the device according to the invention may be partly or totally transparent so that the contact area between the blade and the item to be cut out may be viewed perfectly.

According to an alternative embodiment of the invention, the device according to the invention may also comprise a protective and guiding part positioned under the item to be cut out, the latter being thereby placed between said body of the device according to the invention and said protective and guiding part; Said body, as well as the protective and guiding part, may each comprise an element which may be subject to magnetic attraction, positioned so as to be facing each other when the device according to the invention is in the position of use, so as to ensure attraction of both of these elements. With this protective and guiding part, it is thereby possible:
to still further reinforce the safety of the device according to the invention by not making the blade apparent during cutting operations;
to protect the support, which may be formed by a table, on which the item to be cut out is positioned: this support being protected from involuntary cuts or scratches;
to do without the use of such a support notably due to the stiffness of the protective and guiding part;
to ensure guiding of the cutting operation, which enables it to perform more accurately.

In this scenario, the blade may jut out from the determined area of the surface of the body by a height larger than 10⁴ microns, the protective and guiding part enabling injuries to be prevented.

According to an alternative embodiment of the invention, the body of the device according to the invention may comprise an illumination means of the LED type positioned so as to illuminate the contact area between said blade and the item to be cut out.

The body of the device according to the invention may also comprise a magnifying glass positioned so as to be in the field of view of the user, the latter may thus see said contact area in a magnified way.

According to another alternative, the front portion of the body of the device may be tapered in order to allow the user to have an optimum view of the contact area between said blade and the item to be cut out.

### BRIEF DESCRIPTION OF THE DRAWINGS

Embodiments of the invention will be described hereafter, as non-limiting examples with reference to the appended drawings, wherein:

FIG. 1 is a schematic three quarter view of the face of the device according to the invention.

FIG. 2 is a partial schematic view of one side of the device according to the invention.

FIG. 3 is a schematic view according to a vertical section of the front portion of the body of the device according to the invention.

FIGS. 4a and 4b are schematic views according to a vertical section of the front portion of the body of the device according to an alternative embodiment of the invention.

FIGS. 5a and 5b are schematic views according to a vertical section of the front portion of the body of the device according to another alternative embodiment of the invention;

FIG. 6 is a schematic illustration of a supporting element of a device according an alternative embodiment of the invention.

FIG. 7 is a schematic illustration as seen from the top of the supporting element illustrated in FIG. 6.

FIG. 8 is a schematic illustration as seen from the top of the body and of said supporting element according to an alternative embodiment of the invention.

FIG. 9 is a schematic illustration as seen from the front of the device according to an alternative embodiment of the invention.

FIG. 10a is a schematic illustration as seen from the side of the device according to an alternative embodiment of the invention, in the cutting position.

FIG. 10b is a schematic illustration as seen from the front of the device illustrated in FIG. 10a, in the rest position.

FIG. 10c is a schematic illustration as seen from the side and partly as a section of the device illustrated in FIG. 10a in the disassembled position.

### DESCRIPTION OF THE PREFERRED EMBODIMENTS

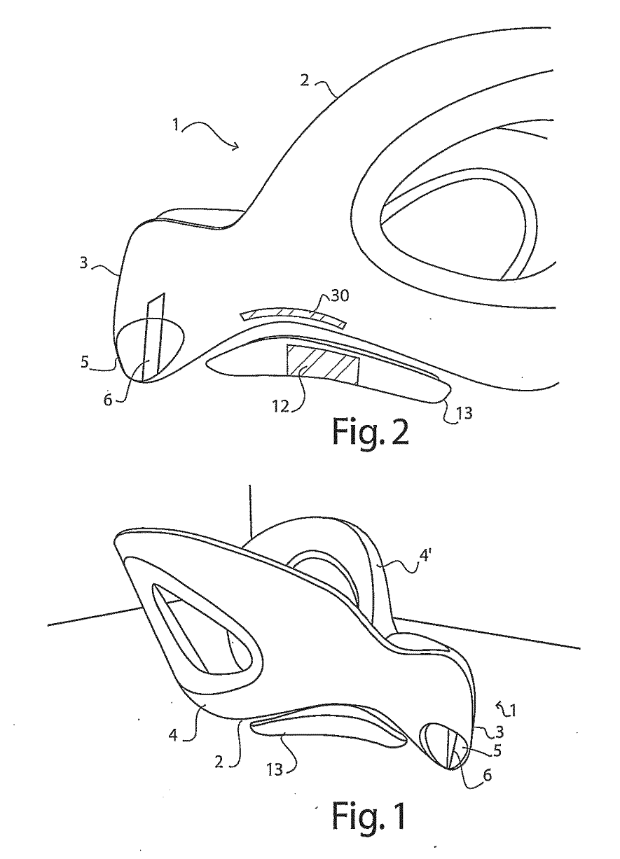

In this example, as this is illustrated in FIGS. 1 and 2, the device according to the invention 1 comprises a body 2 which comprises:
a front portion 3 having at least one ground supporting point;
two wings 4, 4′ facing each other, extending in the extension of the front portion 3 on either side of its longitudinal axis, and the flanks of which are curved outwards, each of these wings 4, 4′ comprising at least one ground supporting point.

The front portion 3 of the body 2 of the device according to the invention 1 comprises at least one cavity 5, the orifice of which is comprised on the lower face of said front portion 3;

The cavity 5 of the front portion 3 of the body 2 of the device according to the invention 1 comprises a blade 6 positioned along a substantially vertical axis so as to be positioned in a plane substantially perpendicular to that of the item to be cut out 7, this blade 6 may be retractable.

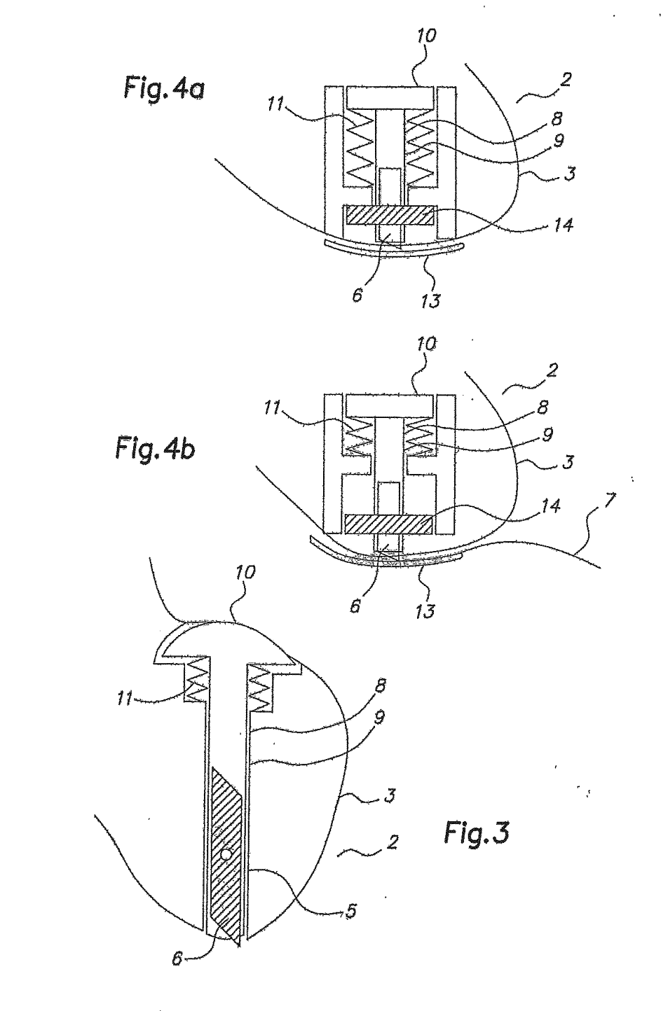

As this is illustrated in FIG. 3, in the case when the blade 6 is retractable, said cavity 5 may also open out on the upper face of said front portion 3, this cavity 5 becoming flared outwards in its upper portion. The cavity 5 then comprises:
a pusher 8 which comprises:
   a rod 9 surmounting said blade 6, or attached to the upper portion of this blade 6;
   a preferably rounded head 10 opening out at the upper face of said front portion 3;
at least one elastic means such as a spring 11 positioned in the space located between the base of the head 10 of the pusher 8 and the base of the flared portion of the cavity 5.

In this way, simple pressure on the head 10 of the pusher 8 enables the lower end of the blade 6 to be deployed out of said body 2, another pressure on the head 10 of the pusher 8 enabling this blade 6 to be retracted.

Advantageously, in the deployed position, the lower end of said blade 6 juts out from said body 2, by a distance of a few microns, preferably 10² microns, with which it is possible to prevent the user from cutting himself/herself.

According to an alternative embodiment, the pusher 8 may be positioned so that its head 10 opens out at the lower face of said body 2. The rod 9 in this case is in contact with the upper portion of the blade 6, appearing in another orifice also opening out at the lower face of said body 2, by means of an intermediate part which may be a jointed lever (not shown). In this way, by laying down the device according to the invention 1 on a support, it is possible to actuate the pusher 8 and therefore cause deployment of the blade 6.

According to another alternative embodiment, the body 2 of the device according to the invention 1 may also comprise a luminous means (not shown) such as a LED which may be comprised on the lower face of the front portion 3 of said body 2 or in a cavity opening into the one 5 where said blade 6 appears, this luminous means being oriented so as to illuminate the contact area between the blade 6 and the item to be cut 7.

Advantageously, the curved shape of the flanks of the wings 4, 4′ of the body 2 gives ergonomics to the assembly facilitating the handling of the device according to the invention 1. Further, the space comprised between the wings 4, 4′ of said body 2 enables the user to better view and therefore better control the cutting-out operation.

According to an alternative embodiment of the invention, as this is notably illustrated in FIG. 4b, in order to optimize control and efficiency of the cutting-out operation, the device according to the invention 1 may also comprise a preferably stiff protective and guiding part 13, positioned under the item to be cut out 7, the latter being thereby placed between said body 2 of the device according to the invention 1 and this protective and guiding part 13.

As this is illustrated in FIG. 2, in order to ensure, when the device according to the invention 1 is in the position of use, attraction between the protective and guiding part 13 and said body 2, the protective and guiding part 13 may comprise, as an example, a magnet 12 positioned so as to be facing a metal element 30 or a magnet of opposite polarity comprised in the front portion 3 of said body 2.

With this protective and guiding part 13 it is notably possible to ensures guiding and control of the cutting-out operation, the element to be cut out 7 being maintained between said body 2 and the protective and guiding part 13.

According to an alternative embodiment of the invention, as this is illustrated in FIGS. 4.a and 4.b, said body 2 may comprise a magnet 14 mobile in vertical translation, connected to said blade 6 or to the rod 9 itself attached to the blade 6. The protective and guiding part 13 may be at least partly made in a metal material in this way, when this protective and guiding part 13 is positioned under the front portion 3 of said body 2, magnetic attraction between the magnet 14 and this part 13 is created and expressed by deployment of the lower end of the blade 6 out of said body 2, this solution having the advantage of making any direct contact between the blade 6 and the user impossible.

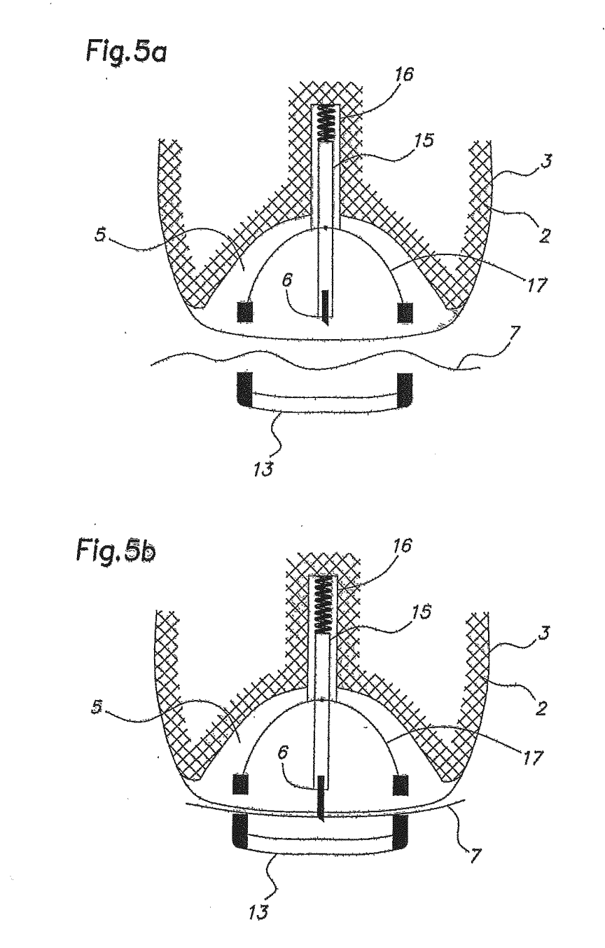

According to another alternative embodiment of the invention, as this illustrated in FIGS. 5.a and 5.b, the front portion 3 of the body 2 of the device according to the invention 1 may comprise a tubular cavity 5 becoming flared at its base and opening out on the lower face of said front portion 3. This cavity 5 may comprise a blade support 15 of a substantially tubular shape attached to the top of said cavity 5 by means of an elastic member 16 such as a cylindrical traction spring, this blade support 15 comprising a fitted-in blade 6, the lower end of which opens out at the base of the blade support 15. The front portion 3 of the body 2 of the device according to the invention 1 also comprises a part 17 substantially having the shape of a dome, the lower perimeter of which consists of metal material. This dome-shaped part 17 is connected with a joint to the blade support 15 substantially at its vertical axis.

The protective and guiding part 13, according to this alternative, substantially has the shape of a ring with a diameter substantially equal to that of the base of the dome-shaped part 17. This protective and guiding part 13 is at least partly magnetized in this way, when this protective and guiding part 13 is positioned under the front portion of said body 2, magnetic attraction is created between the dome-shaped part 17 and the protective and guiding part 13, which is expressed by lowering of the blade support 15 and therefore by deployment of the lower end of the blade 6 out of said body 2.

Advantageously, by attaching the dome-shaped part 17 to the blade support 15 with a joint, it is possible to cause deployment of the blade 6 out of said body 2 only if, when the protective and guiding part 13 is positioned under the front portion of said body 2, said vertical axis of this protective and guiding part 13 coincides with that of the dome-shaped part 17.

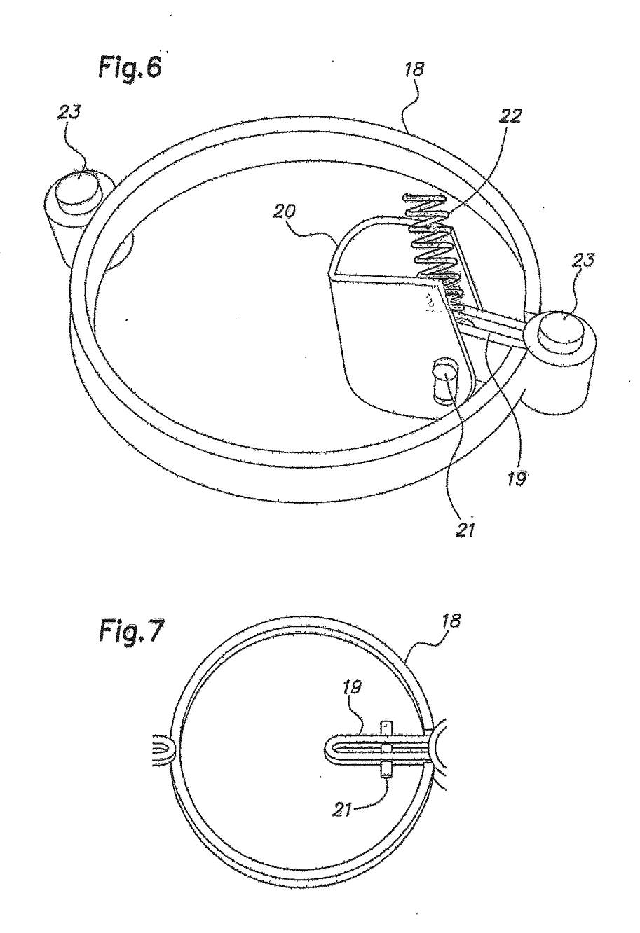

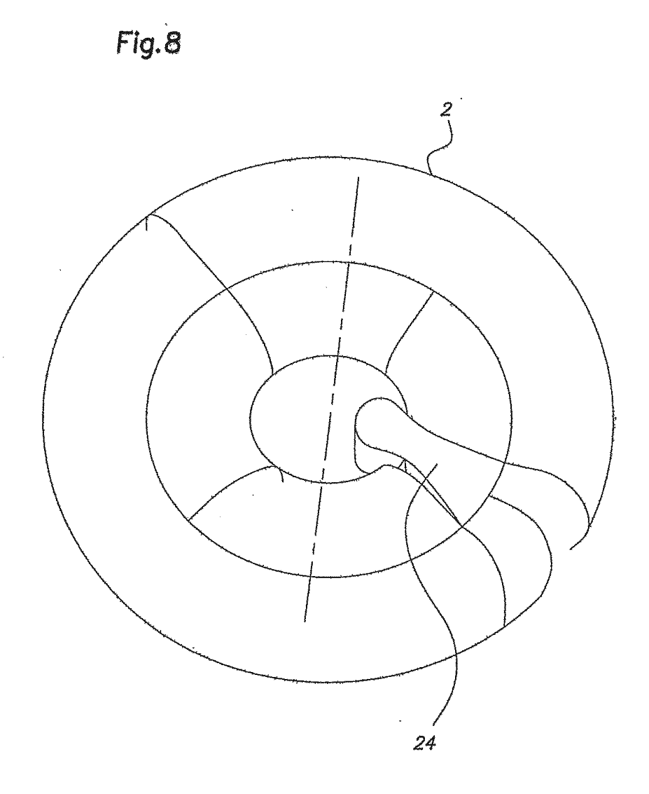

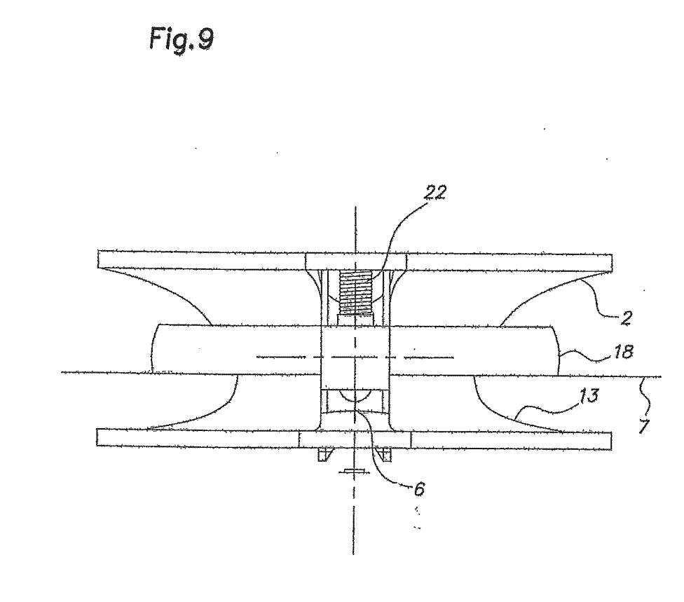

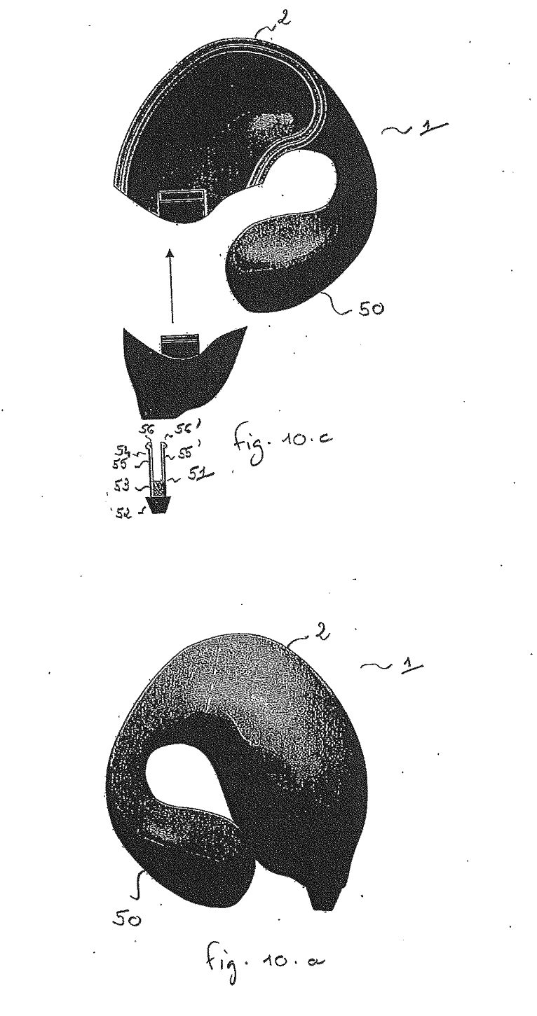

According to another alternative embodiment of the invention, as this is illustrated in FIGS. 6, 7, 8 and 9, the device according to the invention comprises:
a supporting element 18 which substantially has the shape of a ring and comprising:
   an arm 19 which extends radially in the plane delimited by this supporting element 18, this arm 19 along a horizontal section, substantially having the shape of an “n”, the end of each of the two legs of which is connected to the inner edge of the supporting element 18; in this example, each of said legs of the arm 19 comprises a through-orifice centered substantially horizontally, both of these orifices being positioned facing each other;
   a part 20 extending radially and which will partly cover said arm 19, this part 20 along a horizontal section, substantially having the shape of an “n” each flank of which is respectively attached to a leg of said arm 19; each of said flanks comprises a through-orifice centered substantially horizontally, both of these orifices being positioned facing each other; this part 20 is positioned so that its orifices are located on the same horizontal axis as those of said arm 19;
   a connecting item 21 with a substantially cylindrical shape, and which allows the arm 19 to be connected to the part 20 by engagement into their respective orifices;
   an elastic means 22 which may be a spring, connected to the arm 19 and comprised in the space delimited by the part 20, this elastic member 22 extending substantially vertically above said arm 19;
   a blade 6 attached to the lower end of the elastic means 22 and which extends substantially vertically downwards, the top of this blade 6 being positioned in the inner space delimited by the legs of said arm 19;
   at least two magnetic elements 23 with which attraction may be ensured between said supporting element 18 and the protective and guiding part 13; in the case in point, these magnetic elements 23 which substantially have a cylindrical shape, are centered vertically and attached to the external edge of the supporting element 18, these magnetic elements 23 being positioned in the same horizontal axis as the one of said arm 19;
a body 2, the vertical section of which has a flared shape form its base to its top, and which comprises a central through-orifice centered vertically, the base of said body 2 being substantially equal to the diameter of the supporting element 18; the body 2 also comprises an appendix 24 which extends radially in the plane delimited by said body 2, this appendix 24 being conformed so as to be able to cover the arm 19-part 20 assembly of the supporting element 18;
a protective and guiding part 13, the vertical section of which has a flared shape from its top to its base, and which comprises a central through-orifice centered vertically, this protective and guiding part 13 may comprise at least one magnetic element (not shown) positioned so as to be facing a respective magnetic element 23 of the supporting element 18.

In this way, after having connected the supporting element 18 to the body 2 of the device 1 according to the invention (the supporting element 18 being positioned so as to surround the base of said body 2), and having placed an item to be cut out 7 under the thereby formed assembly, the protective and guiding part 13 may be positioned under this item to be cut out 7, the body 2 and this protective and guiding part 13 being connected through magnetic attraction.

Advantageously, the supporting element 18-body 2 assembly is conformed so as to be able to be subject to an oscillating movement around its vertical axis when the protective and guiding part 13 is set into place, this feature making it possible to give the assembly larger handiness.

Advantageously, the device according to the invention 1 may be conformed so that its vertical axis is substantially perpendicular to the plane of the palm of the hand of the user when the latter uses it.

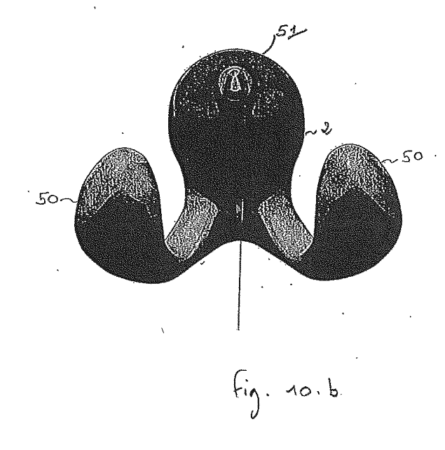

In the example illustrated in FIGS. 10a, 10b and 10c, the cutting-out device 1 comprises a hollow ovoid body 2 extended at one of its ends with two curved massive wings 50 substantially in the shape of a “C”, and returning to the other end of said body 2. These two wings 50 extend symmetrically relatively to the main middle plane of the body 2, by following a path which deviates from said plane, the free ends of these wings 50 forming flarings of a rounded shape located at the height of the free end of said body 2.

This free end of the body 2, which may optionally consist of a portion which may be clip-fastened on said body 2, is provided with an axial bore optionally extended with a chimney into which a removable tool-holder 51 engages and will be clip-fastened, comprising:
a tool-holder head 52 provided with a blade (not shown) which may consist in a blade of the type described above;
a cylindrical section 53 which coaxially extends the base of the head 52 and has a smaller diameter than the latter;
an elastic fork 54 which extends the section and which comprises two parallel branches 55, 55′ each having at its end a radial protrusion 56, 56′ of triangular section used for ensuring axial blocking by snap-on fastening.

The distance comprised between the head 52 and the protrusion 56, 56′ is substantially equal to the length of the bore.

By means of these arrangements, in order to assemble to tool-holder 51 in the body 2, the end of the fork 54 is first of all introduced into the bore. During this introduction, the action of the edge of the bore on the beveled outer face of the protrusions 56, 56′ causes elastic flexure of the branches 55, 55′ of the fork 54 until the protrusions 56, 56′ are engaged into the bore. The cylindrical section 53/fork 54 assembly may then be engaged into the bore until the protrusions 56, 56′ jut out on the outside of the bore. The branches 55, 55′ of the fork 54 then resume their initial position while the protrusions 56, 56′ cooperate with the inner edge of the bore or of the chimney in order to ensure axial blocking of the tool-holder 51 in the body 2.

A particularity of the device described earlier consists in that in the position of use, the ends of the body 2 and of the wings 50 are maintained pressed on the sheet which one wants to cut out, as a tripod. However, the device is not stable in this position. Indeed, the distribution of the masses is provided so that the device topples over as a toppling toy, the wings 50 then playing the role of curved rockers. With this particularity it is possible on the one hand to prevent the support on which the device is laid, from being involuntarily scratched and on the other hand, the blade from being subject to impacts notably upon falling of the device.

Advantageously, the tool-holder 51 may be mounted so as to be able to be subject to a rotary movement relatively to said body 2, which notably allows improvement in the comfort and accuracy of the cutting-out operations.

1-20. (canceled)

21. A device with which it may be proceeded with cutting out material such as paper or cardboard, comprising a body which comprises gripping means, and means for attaching at least one optionally retractable blade, one end of which extends protruding relatively to a determined area of the surface of the body in the position of use of the device,wherein the height of the blade jutting out from the aforesaid area is comprised between 10 microns and 10⁴ microns, preferably 10² microns and wherein area has a relatively larger surface area of the order of 0.5 to 15 cm².

22. The device according to claim 21, wherein the upper portion of the body of this device has shape conformity with that of the palm of the hand of a child so that the latter may hold said device with ease and steadiness.

23. The device according to claim 22, wherein the upper portion of the body of this device is convex while its lower portion comprises at least three supporting points with which large stability may be provided to said body.

24. The device according to claim 22, comprising a body which comprises:
a front portion having at least one ground supporting point;
two wings facing each other, extending in the extension of the front portion on either side of its longitudinal axis, and the flanks of which are curved outwards, each of these wings comprising at least one ground supporting point.

25. The device according to claim 24, wherein the front portion of the body of the device comprises at least one cavity, the orifice of which is comprised on the lower face of said front portion; the cavity of the front portion of the body comprises the blade positioned along a substantially vertical axis so as to be positioned in a plane substantially perpendicular to the one of the item to be cut out, this blade may be retractable.

26. The device according to claim 25, wherein the case when the blade is retractable, the cavity also opens out on the upper face of said front portion, this cavity becoming flared outwards in its upper portion; the cavity then comprises:
a pusher which comprises:
a rod surmounting said blade, or attached to the upper portion of this blade;
a preferably rounded head opening out at the upper face of said front portion;
at least one elastic means such as a spring positioned in the space located between the base of the head of the pusher and the base of the flared portion of the cavity;
in this way, simple pressure on the head of the pusher (enables deployment of the lower end of the blade out of said body, another pressure on the head of the pusher enabling retraction of this blade.

27. The device according to claim 22, comprising a protective and guiding part positioned under the item to be cut out, the latter being thereby placed under said body of the device and this protective and guiding part; said body as well as the protective and guiding part each comprising an element which may be subject to magnetic attraction, positioned so as to be facing each other when the device is in the position of use, so as to ensure attraction of both of these elements.

28. The device according to claim 27, wherein the body comprises a magnet mobile in vertical translation, connected to said blade or to the rod itself attached to the blade; the protective and guiding part is at least made partly in metal material in this way, when this protective and guiding part is positioned under the front portion of said body, magnetic attraction between the magnet and this part is created and expressed by deployment of the lower end of the blade out of said body.

29. The device according to claim 27, wherein the front portion of the body comprises a tubular cavity becoming flared at its base and opening out on the lower face of said front portion; this cavity comprises a blade support with a substantially tubular shape attached to the top of said cavity by means of an elastic member such as a cylindrical traction spring, this blade support comprising a fitted-in blade, the lower end of which opens out at the base of the blade support; the front portion of the body of the device also comprises a part substantially having the shape of a dome, the lower perimeter of which consists of a metal material, this dome-shaped part being connected with a joint to the blade support substantially at its vertical axis; the protective and guiding part substantially has the shape of a ring having a diameter substantially equal to that of the base of the dome-shaped part, further this protective and guiding part is at least partly magnetized in this way, when this protective and guiding part is positioned under the front portion of said body, magnetic attraction is created between the dome-shaped part and the protective and guiding part, which is expressed by lowering of the blade support and therefore by deployment of the lower end of the blade out of said body; with the jointed attachment of the dome-shaped part to the blade support, it is possible to cause deployment of the blade out of said body only if, when the protective and guiding part is positioned under the front portion of said body, the vertical axis of this protective and guiding part coincides with that of the dome-shaped part.

30. The device according to claim 27, comprising:
a supporting element which substantially has the shape of a ring and comprising:
an arm which extends radially in the plane delimited by this supporting element, this arm having along a horizontal section, substantially the shape of an “n”, the end of each of the two legs is connected to the inner edge of the supporting element; each of said legs of the arm comprises a through-orifice centered substantially horizontally, both of these orifices being positioned facing each other;
a part extending radially and which will partly cover said arm, this part along a horizontal section, substantially having the shape of an “n”, each flank of which is respectively attached to a leg of said arm; each of said flanks comprises a through-orifice centered substantially horizontally, both of these orifices being positioned facing each other; this part is positioned so that its orifices are located on the same horizontal axis as those of said arm;
a connecting item with a substantially cylindrical shape, and which allows the arm to be connected to the part by engagement into their respective orifices;
an elastic means which may be a spring, connected to the arm and comprised in the space delimited by the part, this elastic member extending substantially vertically above said arm;
a blade attached to the lower end of the elastic means and which extends substantially vertically downwards, the top of this blade being positioned in the inner space delimited by the legs of said arm;
at least two magnetic elements with which attraction may be ensured between said supporting element and the protective and guiding part; in the case in point, these magnetic elements which substantially have a cylindrical shape, are centered vertically and are attached to the external edge of the supporting element, these magnetic elements being positioned in the same horizontal axis as the one of said arm;
a body, the vertical section of which has a flared shape from its base to its top, and which comprises a central through-orifice centered vertically, the base of said body being substantially equal to the diameter of the supporting element; the body also comprises an appendix which extends radially in the plane delimited by said body, this appendix being conformed so as to be able to cover the arm - part assembly of the supporting element;
a protective and guiding part, the vertical section of which has a flared shape from its top to its base, and which comprises a central through-orifice centered vertically, this protective and guiding part may comprise at least one magnetic element positioned so as to be facing a respective magnetic element of the supporting element;
in this way, after having connected the supporting element to the body of the device, the supporting element being positioned so as to surround the base of said body, and having placed an item to be cut out under the thereby formed assembly, the protective and guiding part may be positioned under this item to be cut out, the body and this protective and guiding part being connected by magnetic attraction.

31. The device according to claim 30, wherein the supporting element body assembly is conformed so as to be able to be subject to an oscillating movement around its vertical axis when the protective and guiding part is set into place.

32. The device according to claim 22, wherein the blade juts out from the determined area of the surface of the body with a height larger than 10⁴ microns.

33. The device according to claim 22, wherein the body of this device is transparent in order to be able to perfectly view the contact area between the blade and the item to be cut out.

34. The device according to claim 22, wherein the body of this device comprises an illumination means of the LED type positioned so as to illuminate the contact area between said blade and the item to be cut out.

35. The device according to claim 22, wherein the front portion of the body of this device is tapered in order to allow the user to have optimum use of the contact area between said blade and the item to be cut out.

36. The device according to claim 22, comprising a hollow ovoid body extended at one of its ends with two massive wings substantially curved as a “C”, and returning towards the other end of said body; both of these wings extend symmetrically relatively to the main middle plane of the body, by following a path which deviates from said plane, the free ends of these wings forming flarings of a rounded shape located at the height of the free end of said body; this free end of the body is provided with an axial bore possibly extended with a chimney into which a removable tool-holder engages and will be fastened by clips, comprising:
a tool-holder head provided with a blade which may consist in a blade of the aforesaid type;
a cylindrical section which coaxially extends the base of the head and has a smaller diameter than the latter;
an elastic fork which extends the section and which comprises two parallel branches each having at its end a radial protrusion of triangular section used for ensuring axial blocking by snap-on fastening;
the distance comprised between the head and the protrusions being substantially equal to the length of the bore.

37. The device according to claim 36, wherein said free end of the body consists of a portion which may be fastened by clips on said body.

38. The device according to claim 36, wherein for assembling the tool-holder in the body, the end of the fork is first of all introduced into the bore; during this introduction, the action of the edge of the bore on the beveled outer face of the protrusions causes elastic flexure of the branches of the fork until the protrusions are engaged into the bore; the cylindrical section/fork assembly may be engaged into the bore until the protrusions jut out on the outside of the bore; the branches of the fork then resume their initial position while the protrusions cooperate with the inner edge of the bore or of the chimney in order to ensure axial blocking of the tool-holder in the body.

39. The device according to claim 36, wherein in the position of use, the ends of the body and of the wings are maintained pressed on the sheet which is intended to be cut out, in the fashion of a tripod; however, the device is not stable in this position, indeed distribution of the masses is provided so that the device topples over as a toppling toy, the then playing the role of curved rockers.

40. The device according to claim 36, wherein the tool-holder is mounted so as to be able to be subject to a rotary motion relatively to said body, which notably allows improvement in the comfort and the accuracy of the cutting-out operations.
